(19) United States
(12) Patent Application Publication
(10) Pub. No.: US 2025/0347332 A1
(43) Pub. Date: Nov. 13, 2025

(54) FRICTION DISK HAVING MULTIPLE FRICTION MATERIALS

(71) Applicant: DEERE & COMPANY, MOLINE, IL (US)

(72) Inventors: ROGER W. BURJES, CEDAR FALLS, IA (US); JONATHAN D. BRIDGES, WATERLOO, IA (US)

(21) Appl. No.: 18/934,464

(22) Filed: Nov. 1, 2024

Related U.S. Application Data
(60) Provisional application No. 63/645,190, filed on May 10, 2024.

(51) Int. Cl. F16D 69/00; F16D 13/64; F16D 65/12

(52) U.S. Cl. CPC F16D 69/00; F16D 13/64; F16D 65/127; F16D 2069/002; F16D 2069/004

(57) ABSTRACT

A friction disk includes a disk, a first friction material positioned on a first side of the disk, the first friction material having a first set of material properties, and a second friction material positioned radially outward from the first friction material on the first side of the disk, the second friction material having a second set of material properties different from the first set of material properties.

### CROSS-REFERENCE TO RELATED APPLICATIONS

This application claims the benefit of U.S. Provisional Application No. 63/645,190, titled FRICTION DISK HAVING MULTIPLE FRICTION MATERIALS, filed May 10, 2024, which is hereby incorporated by reference.

### FIELD OF THE DISCLOSURE

The present disclosure relates to a friction disk having multiple friction materials.

### BACKGROUND

A clutch or brake disk can include an inner metal core with a friction material arranged on one or both sides of the core. The friction material can include a pattern of grooves which allows a lubricating or cooling fluid to flow across the friction material within the pattern of grooves. The fluid can flow from the inner diameter of the clutch or brake disk to the outer diameter transferring heat away from the friction material.

### SUMMARY

According to an aspect of the present disclosure, a friction disk includes a disk, a first friction material positioned on a first side of the disk, the first friction material having a first set of material properties, and a second friction material positioned radially outward from the first friction material on the first side of the disk, the second friction material having a second set of material properties different from the first set of material properties.

According to an aspect of the present disclosure, the first set of material properties includes one or more of a first coefficient of friction, a first stiffness, and a first thickness, and the second set of material properties includes one or more of a second coefficient of friction, a second stiffness, and a second thickness.

According to an aspect of the present disclosure, the first set of material properties includes one or more of a first groove pattern, a first radial width, a first coefficient of friction, a first stiffness, and a first thickness, and the second set of material properties includes one or more of a second groove pattern, a second radial width, a second coefficient of friction, a second stiffness, and a second thickness.

According to an aspect of the present disclosure, the friction disk further includes a third friction material positioned radially outward from the first friction material on the first side of the disk, the third friction material having a third set of material properties different from the first set of material properties and the second set of material properties.

According to an aspect of the present disclosure, the friction disk is used with a brake assembly.

According to an aspect of the present disclosure, the friction disk is used with a clutch assembly.

The above and other features will become apparent from the following detailed description and accompanying drawings.

### BRIEF DESCRIPTION OF THE DRAWINGS

The detailed description of the drawings refers to the accompanying figures in which:

FIG. 1 is a front view of a friction disk, according to one implementation;

FIG. 2 is a front view of a friction disk, according to one implementation;

FIG. 3 is a side view of a friction disk, according to one implementation;

FIG. 4 is an enlarged view of detail A in FIG. 3, according to one implementation;

FIGS. 5A-F are enlarged views of detail A in FIG. 3, according to one implementation;

FIG. 6 a perspective view of a brake assembly, according to one implementation;

FIG. 7 is an is partial perspective view of a brake assembly, according to one implementation; and

FIG. 8 is a thermal image of a brake assembly, according to one implementation.

Like reference numerals are used to indicate like elements throughout the figures.

### DETAILED DESCRIPTION

The implementations disclosed in the above drawings and the following detailed description are not intended to be exhaustive or to limit the disclosure to these implementations.

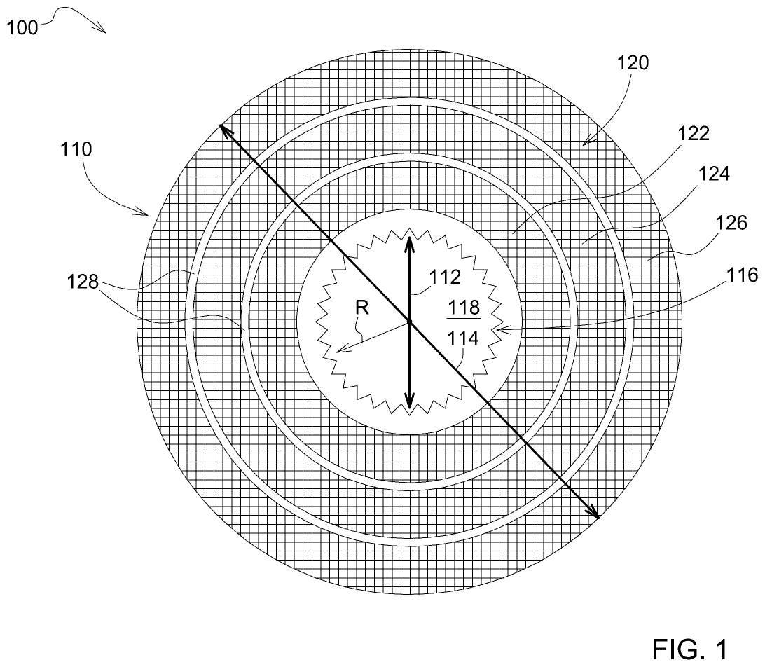

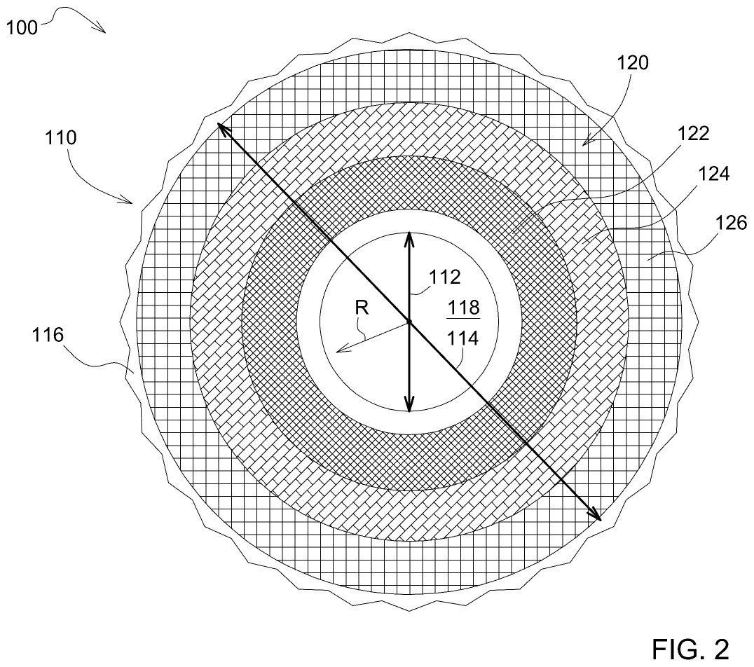

With reference to FIGS. 1-3, a friction disk 100, for example a brake disk or a clutch disk, can be used in a brake assembly or a clutch assembly. The friction disk 100 includes a disk 110 having an inner diameter 112 and an outer diameter 114. The friction disk 100 includes an opening 118 in the center. The disk 110 can include splines or teeth 116 on the inner diameter 112, the outer diameter 114, or both.

The friction disk 100 includes friction material 120 on one or both sides of the disk 110. The friction material 120 can include different or varying material properties, such as coefficient of friction, stiffness, and thickness. The friction material 120 can include different or varying coefficients of friction, stiffnesses, thicknesses, or any combination of these material properties. The friction material 120 can include different or varying other material properties in addition to or separate from the coefficient of friction, stiffness, and thickness, for example, radial width, groove pattern, or any combination of these material properties. The friction material 120 can include one integral piece of friction material with one or more different or varying material properties. The friction material 120 can include one or more different or varying material properties from the inner diameter to the outer diameter. The friction material 120 can include a plurality of friction materials, each having one or more different material properties. The friction material 120 can include two, three, or more different friction materials.

The friction material 120 can include a first friction material 122 on a first side of the disk 110 and a second friction material 124 in proximity or adjacent to the first friction material 122. The second friction material 124 can be positioned radially outward from the first friction material 122. The first and second friction materials 122, 124 can form one integral piece or can be separate pieces. The first and second friction materials 122, 124 can form a continuous surface or can be spaced apart forming a gap or opening 128 between the first and second friction materials 122, 124. The second friction material 124 can abut or be spaced apart from the first friction material 122. The first friction material 122 has a first set of material properties. The second friction material 124 has a second set of material properties different from the first set of material properties. The first and second material properties can vary by a large or small amount. The first and second material properties can include, but are not limited to, one or more of coefficient of friction, stiffness, and thickness. The first and second material properties can include, but are not limited to, one or more of groove pattern, radial width, coefficient of friction, stiffness, and thickness.

The first and second friction materials 122, 124 can have the same or different coefficients of friction. The first and second friction materials 122, 124 can have a constant or a varying coefficient of friction. Either of the first or second friction materials 122, 124 can have the larger or smaller coefficient of friction relative to each other. The first and second friction materials 122, 124 can have the same or different stiffnesses or rigidity. The first and second friction materials 122, 124 can have a constant or a varying stiffness or rigidity. Either of the first or second friction materials 122, 124 can have the larger or smaller stiffness or rigidity relative to each other. The first and second friction materials 122, 124 can have the same or different thicknesses. The first and second friction materials 122, 124 can have a constant or a varying thickness. Either of the first or second friction materials 122, 124 can have the larger or smaller thickness relative to each other.

The first and second friction materials 122, 124 can have the same or different widths in the radial direction R. The first and second friction materials 122, 124 can have a constant or a varying width. Either of the first or second friction materials 122, 124 can have the larger or smaller width relative to each other. The first or second friction materials 122, 124 can have one or more grooves on each friction surface. The first or second friction materials 122, 124 can have the same or different groove patterns on each friction surface. The first or second friction materials 122, 124 can have any combination of material properties. The first or second friction materials 122, 124 can have any combination of groove patterns, radial widths, coefficients of friction, stiffnesses, and thicknesses. When the friction material 120 is on both sides of the disk 110, the friction material 120 can be arranged the same or differently on each side of the disk 110.

The friction material 120 can include a first friction material 122 in proximity or adjacent to the inner diameter, a second friction material 124 in proximity or adjacent to the first friction material 122, and a third friction material 126 in proximity or adjacent to the outer diameter 114. The second friction material 124 can be positioned radially outward from the first friction material 122, and the third friction material 126 can be positioned radially outward from the second friction material 124. The first, second, and third friction materials 122, 124, 126 can form one integral piece, or the first, second, and third friction materials 122, 124, 126 can be separate pieces.

The first, second, and third friction materials 122, 124, 126 can form a continuous surface, or the first, second, and third friction materials 122, 124, 126 can be spaced apart forming a gap or opening 128 between each of the first, second, and third friction materials 122, 124, 126. The second friction material 124 can abut or be spaced apart from the first friction material 122. The third friction material 126 can abut or be spaced apart from the second friction material 124.

The first friction material 122 has a first set of material properties. The second friction material 124 has a second set of material properties different from the first set of material properties. The third friction material 126 has a third set of material properties different from either the first set of material properties or the second set of material properties or both. The first, second, and third material properties can vary by a large or small amount. The first, second, and third material properties can include, but are not limited to, one or more of coefficient of friction, stiffness, and thickness. The first, second, and third material properties can include, but are not limited to, one or more of groove pattern, radial width, coefficient of friction, stiffness, and thickness.

The first, second, and third friction materials 122, 124, 126 can have the same or different coefficients of friction. Each of the first, second, and third friction materials 122, 124, 126 can have a constant or a varying coefficient of friction. Any of the first, second, and third friction materials 122, 124, 126 can have the largest, intermediate, or smallest coefficient of friction relative to each other. For example, the first friction material 122 can have the largest or highest coefficient of friction, the second friction material 124 can have the intermediate coefficient of friction, and the third friction material 126 can have the smallest or lowest coefficient of friction. The intermediate coefficient of friction can be any coefficient of friction between the smallest and the largest coefficients of friction. The different coefficients of friction can be in any other arrangement.

The first, second, and third friction materials 122, 124, 126 can have the same or different stiffnesses or rigidity. Each of the first, second, and third friction materials 122, 124, 126 can have a constant or a varying stiffness. Any of the first, second, and third friction materials 122, 124, 126 can have the largest, intermediate, or smallest stiffness relative to each other. For example, the first friction material 122 can have the largest or highest stiffness, the second friction material 124 can have the intermediate stiffness, and the third friction material 126 can have the smallest or lowest stiffness. The intermediate stiffness can be any stiffness between the smallest and largest stiffnesses. The different stiffnesses can be in any other arrangement.

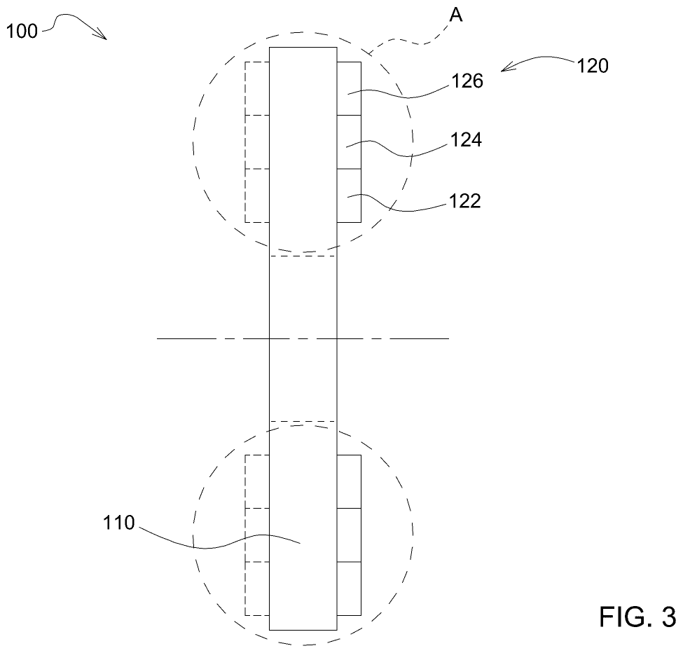

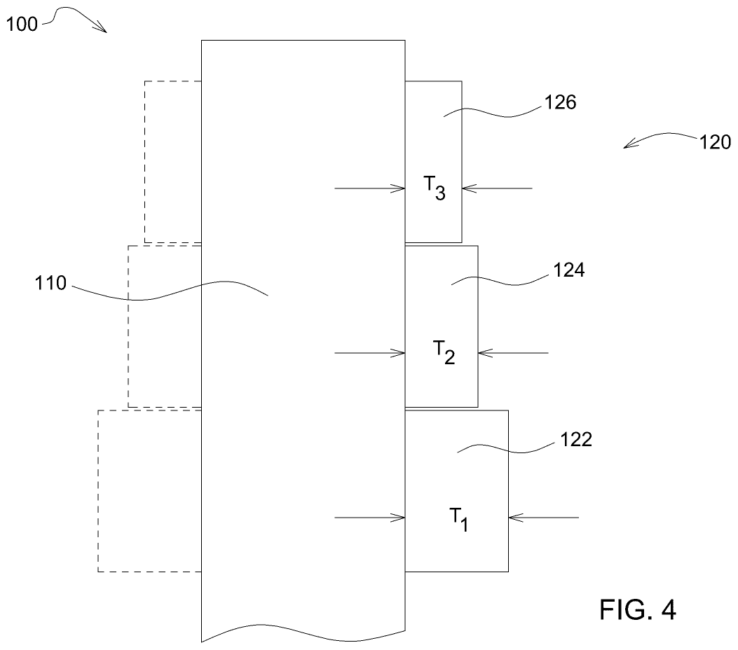

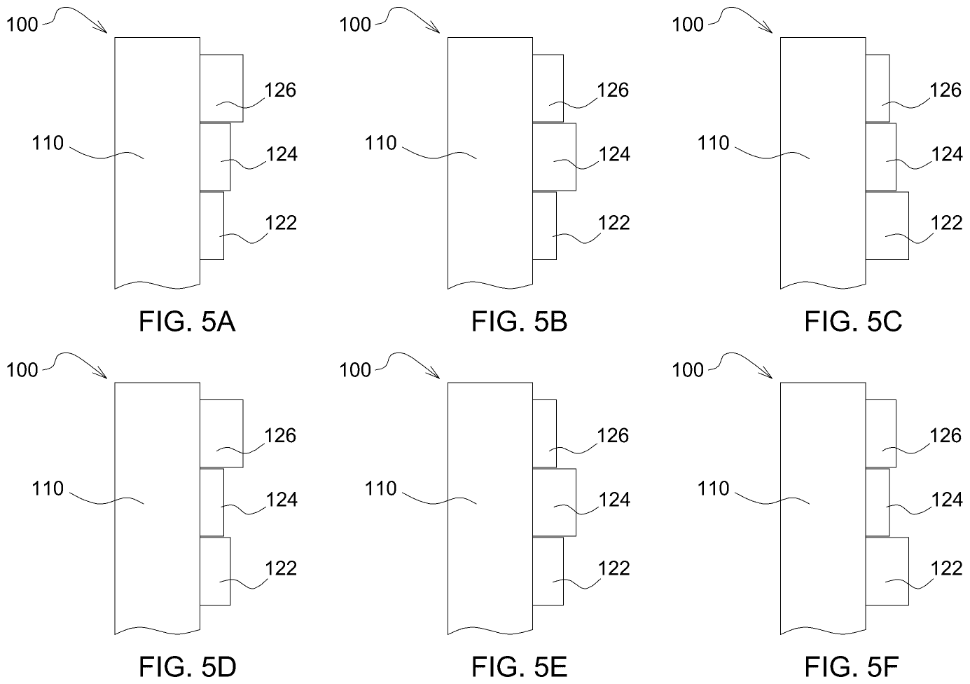

With reference to FIGS. 3, 4, and 5A-F, first, second, and third friction materials 122, 124, 126 can have the same or different thicknesses. Each of the first, second, and third friction materials 122, 124, 126 can have a constant or a varying thickness. Any of the first, second, and third friction materials 122, 124, 126 can have the largest, intermediate, or smallest thickness relative to each other. The first friction material 122 can have a first thickness T1, the second friction material 124 can have a second thickness T2, and the third friction 126 material can have a third thickness T3. For example, the first friction material 122 can have the largest or greatest thickness, the second friction material 124 can have the intermediate thickness, and the third friction material 126 can have the smallest or least thickness. The intermediate thickness can be any thickness between the smallest and largest thicknesses. The different thicknesses can be in any other arrangement, as shown for example in FIGS. 5A-F.

The first, second, and third friction materials 122, 124, 126 can have the same or different widths in the radial direction R. Each of the first, second, and third friction materials 122, 124, 126 can have a constant or a varying width. Any of the first, second, and third friction materials 122, 124, 126 can have the largest, intermediate, or smallest radial width relative to each other. The intermediate radial width can be any width between the largest and the smallest radial widths. Each of the first, second, and third friction materials 122, 124, 126 can have one or more grooves on each friction surface. The first, second, and third friction materials 122, 124, 126 can have the same or different groove patterns on each friction surface.

Each of the first, second, and third friction materials 122, 124, 126 can have any combination of material properties. Each of the first, second, and third friction materials 122, 124, 126 can have any combination of groove patterns, radial widths, coefficients of friction, stiffnesses, and thicknesses. When the friction material 120 is on both sides of the disk 110, the friction material 120 can be arranged the same or differently on each side of the disk 110.

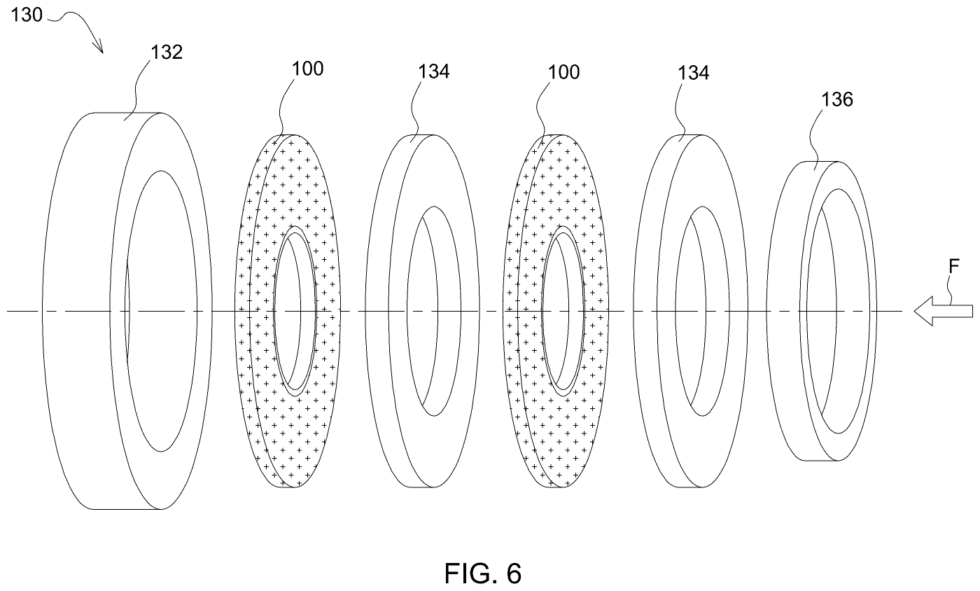

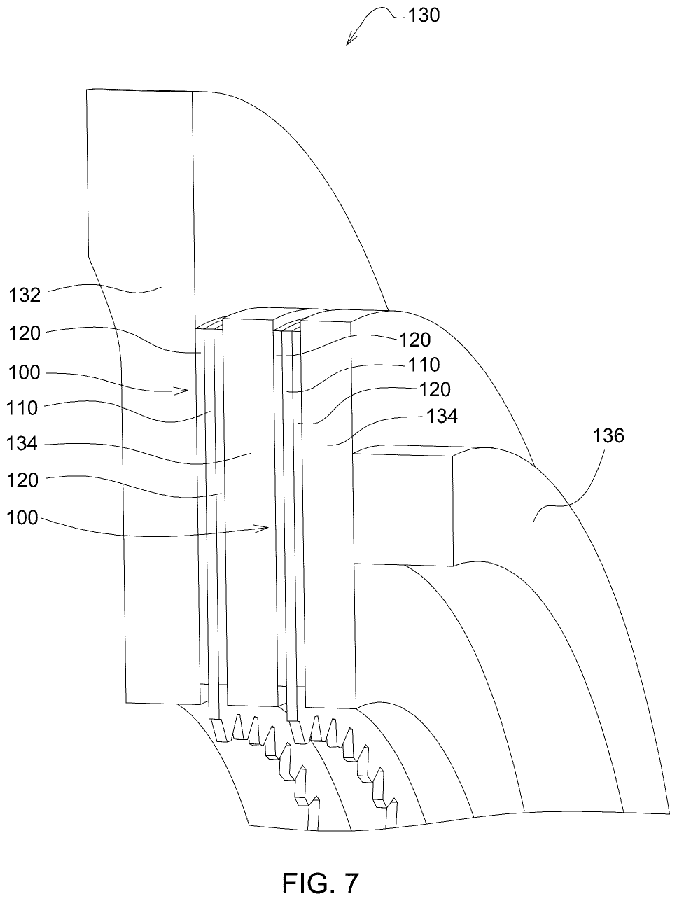

With reference to FIGS. 6-8, the friction disk 100 can be used in a brake assembly 130 of an axle of a work vehicle, for example a rear axle of an agricultural tractor, according to some implementations. This disclosure also applies to other types of work vehicles in agriculture, construction, forestry, and road building. The brake assembly 130 can include a backing plate 132, one or more friction disks 100, one or more brake plates 134, and a brake piston 136. A friction disk 100 is positioned between the backing plate 132 and one of the brake plates 134. Another friction disk 100 is positioned between two brake plates 134, 134. The one or more friction disks 100 can rotate relative to the backing plate 132 and the one or more brake plates 134. The brake assembly 130 is engaged via the brake piston 136 exerting a force F on the brake plates 134 and the friction disks 100 towards the backing plate 132. The friction between the friction disks 100 and the brake plates 134 and between the friction disk 100 and the backing plate 132 generates heat due to the difference in relative speed between the rotating and non-rotating components.

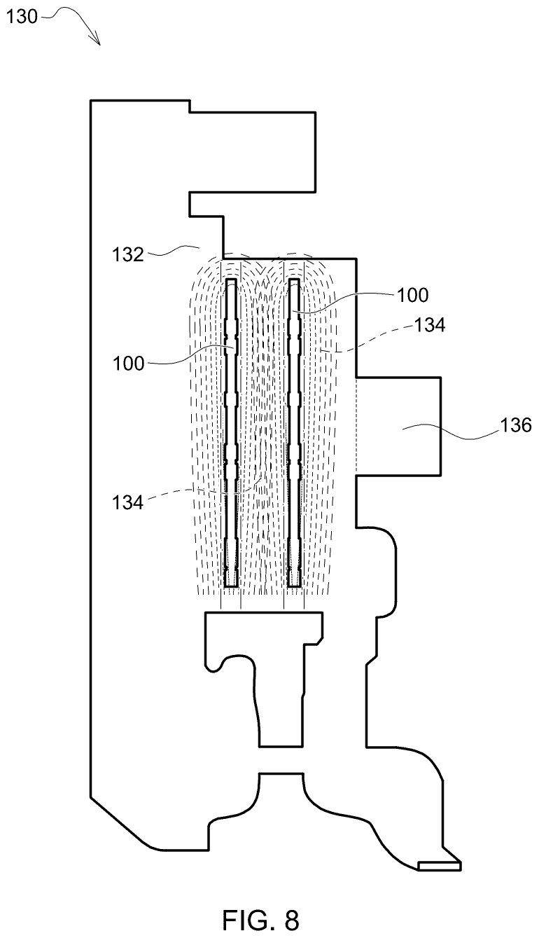

With reference to FIG. 8, thermal analysis can show the temperature distribution of the heat generated when a clutch or brake assembly is engaged. If the thermal analysis shows areas of higher temperatures, then the friction material 120 can be adjusted or modified to redistribute the temperature profile. Adjusting or modifying the groove patterns, radial widths, coefficients of friction, stiffnesses, or thicknesses of the friction material 120 can affect the temperature distribution.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

What is claimed is:

1. A friction disk comprising:
a disk;
a first friction material positioned on a first side of the disk, the first friction material having a first set of material properties; and
a second friction material positioned radially outward from the first friction material on the first side of the disk, the second friction material having a second set of material properties different from the first set of material properties.

2. The friction disk of claim 1, wherein the first set of material properties includes one or more of a first coefficient of friction, a first stiffness, and a first thickness, and the second set of material properties includes one or more of a second coefficient of friction, a second stiffness, and a second thickness.

3. The friction disk of claim 1, wherein the first set of material properties includes one or more of a first groove pattern, a first radial width, a first coefficient of friction, a first stiffness, and a first thickness, and the second set of material properties includes one or more of a second groove pattern, a second radial width, a second coefficient of friction, a second stiffness, and a second thickness.

4. The friction disk of claim 1, wherein the first set of material properties includes a first coefficient of friction, the second set of material properties includes a second coefficient of friction, and the first coefficient of friction is larger than the second coefficient of friction.

5. The friction disk of claim 1, wherein the first set of material properties includes a first stiffness, the second set of material properties includes a second stiffness, and the first stiffness is larger than the second stiffness.

6. The friction disk of claim 1, wherein the first set of material properties includes a first thickness, the second set of material properties includes a second thickness, and the first thickness is larger than the second thickness.

7. The friction disk of claim 1, wherein the first set of material properties includes a first groove pattern, and the second set of material properties includes a second groove pattern different from the first groove pattern.

8. The friction disk of claim 1, wherein the first set of material properties includes a first radial width, and the second set of material properties includes a second radial width, and the different from the first radial width.

9. The friction disk of claim 1, further comprising:
a third friction material positioned radially outward from the second friction material on the first side of the disk, the third friction material having a third set of material properties different from the first set of material properties and the second set of material properties.

10. The friction disk of claim 9, wherein the first set of material properties includes one or more of a first coefficient of friction, a first stiffness, and a first thickness, the second set of material properties includes one or more of a second coefficient of friction, a second stiffness, and a second thickness, the third set of material properties includes one or more of a third coefficient of friction, a third stiffness, and a third thickness.

11. An assembly including a friction disk, comprising:
a disk;
a first friction material positioned on a first side of the disk, the first friction material having a first set of material properties; and
a second friction material positioned radially outward from the first friction material on the first side of the disk, the second friction material having a second set of material properties different from the first set of material properties.

12. The assembly of claim 11, wherein the first set of material properties includes one or more of a first coefficient of friction, a first stiffness, and a first thickness, and the second set of material properties includes one or more of a second coefficient of friction, a second stiffness, and a second thickness.

13. The assembly of claim 11, wherein the first set of material properties includes one or more of a first groove pattern, a first radial width, a first coefficient of friction, a first stiffness, and a first thickness, and the second set of material properties includes one or more of a second groove pattern, a second radial width, a second coefficient of friction, a second stiffness, and a second thickness.

14. The assembly of claim 11, wherein the first set of material properties includes a first coefficient of friction, the second set of material properties includes a second coefficient of friction, and the first coefficient of friction is larger than the second coefficient of friction.

15. The assembly of claim 11, wherein the first set of material properties includes a first stiffness, the second set of material properties includes a second stiffness, and the first stiffness is larger than the second stiffness.

16. The assembly of claim 11, wherein the first set of material properties includes a first thickness, the second set of material properties includes a second thickness, and the first thickness is larger than the second thickness.

17. The assembly of claim 11, wherein the first set of material properties includes a first groove pattern, and the second set of material properties includes a second groove pattern different from the first groove pattern.

18. The assembly of claim 11, wherein the first set of material properties includes a first radial width, and the second set of material properties includes a second radial width, and the different from the first radial width.

19. The assembly of claim 11, further comprising:
a third friction material positioned radially outward from the second friction material on the first side of the disk, the third friction material having a third set of material properties different from the first set of material properties and the second set of material properties.

20. The assembly of claim 19, wherein the first set of material properties includes one or more of a first coefficient of friction, a first stiffness, and a first thickness, the second set of material properties includes one or more of a second coefficient of friction, a second stiffness, and a second thickness, the third set of material properties includes one or more of a third coefficient of friction, a third stiffness, and a third thickness.
